(19) United States
(12) Patent Application Publication
(10) Pub. No.: US 2011/0128415 A1
(43) Pub. Date: Jun. 2, 2011

(54) IMAGE PROCESSING DEVICE AND IMAGE-SHOOTING DEVICE

(75) Inventor: Masahiro YOKOHATA, Osaka-City (JP)

(73) Assignee: SANYO ELECTRIC CO., LTD., Osaka (JP)

(21) Appl. No.: 12/956,363

(22) Filed: Nov. 30, 2010

(30) Foreign Application Priority Data
Nov. 30, 2009 (JP) 2009-272128

(51) Int. Cl. H04N 5/262

(52) U.S. Cl. 348/239; 348/E05.051

(57) ABSTRACT

The image processing device comprises a background/subject identification portion which identifies respectively, for each of a plurality of burst-shot images shot successively over time, a background area which is an area representing a background, and a subject area which is an area representing a subject; a background image generation portion which generates a background image which is an image representing a background, on the basis of the background area identified by the background/subject identification portion; a subject image generation portion which generates a subject image which is an image representing a subject, on the basis of the subject area identified by the background/subject identification portion; a correction portion which derives a direction of motion of a subject on the basis of the subject area identified by the background/subject identification portion, and which performs correction of the background image to create blur along the direction of motion of the subject; and a synthesis portion which synthesizes the subject image with the background image corrected by the correction portion.

This application is based on Japanese Patent Application No. 2009-272128 filed on Nov. 30, 2009, the contents of which are hereby incorporated by reference.

### BACKGROUND OF THE INVENTION

1. Field of the Invention

The present invention relates to an image processing device adapted to generate a new image from a plurality of input images; and to an image-shooting device furnished with the image processing device and adapted to shoot a plurality of images.

2. Description of Related Art

In a well-known image shooting technique known as “blurred background,” an image-shooting device is moved in tandem with motion of a subject (an object primarily intended to be photographed and capable of being distinguished from the background, herein termed simply a “subject”) while the subject is photographed so as to remain within the angle of view. In images shot using this technique, the subject is in clear focus while the background is indistinct (blurred) in the direction of motion of the subject, so as to effectively represent motion (action) of the subject.

However, taking such “blurred background” pictures necessitates moving the image-shooting device in tandem with a moving subject, which has not been easy for beginners to do. Accordingly, there have been proposed a number of image-shooting devices that, through image post-processing of shot images, are able to impart a blurred background effect to the images, without actually requiring that the image-shooting device move in tandem with the subject.

For example, there has been proposed an image-shooting device adapted to detect a subject area from each of a plurality of shot images, and to then synthesize the plurality of images so as to align their respective subject areas to create an image in which the background is blurred according to the direction of motion and extent of motion of the subject.

However, a problem with this sort of image-shooting device is that if the size and shape of the subject in the images do not match, the subject in the image obtained through processing will be indistinct. Moreover, if the subject happens to move in a complex fashion, background blur may not coincide with motion of the subject, creating the problem of an unnatural appearance.

There has also been proposed an image-shooting device adapted to detect the subject area from a single image and to estimate the direction of motion and extent of motion of the subject, and on the basis of the estimated information to perform a different correction on each region of the image in order to correct blur of the subject area to make it distinct, as well as to obtain an image in which the background area is blurred according to the direction of motion and extent of motion of the subject.

However, a problem with such an image-shooting device is that unless identification of the subject area and estimation of the direction of motion and extent of motion are carried out with good accuracy, the subject may be indistinct in the corrected image, or background blur may not coincide with motion of the subject, creating the problem of an unnatural appearance.

Yet another proposed an image-shooting device is adapted to identify the subject and its direction of motion prior to shooting, and to then shoot a background image that does not contain the subject, as well an image containing both the background and the subject, and to then compare these images to generate a subject image; the subject image is then synthesized with a background image blurred in the direction of motion of the subject to obtain the final image.

However, a problem with such an image-shooting device is that, because of the need to shoot background image after the image containing the subject has been shot, the series of images cannot end until the subject moves out of frame. In instances of an extended time until the subject moves out of frame, there is a high probability of change in the background or shooting environment (such as ambient brightness), and depending on the change it may be impossible to generate a good subject image, or differences in brightness or other attributes between the background image and the subject image may arise. A resultant problem is that the subject may be indistinct in the synthesized image, or there may be noticeable inconsistency between the subject and the background in the synthesized image.

### SUMMARY OF THE INVENTION

The image processing device of the present invention comprises:

a background/subject identification portion which identifies respectively, for each of a plurality of burst-shot images shot successively over time, a background area which is an area representing a background, and a subject area which is an area representing a subject;

a background image generation portion which generates a background image which is an image representing a background, on the basis of the background area identified by the background/subject identification portion;

a subject image generation portion which generates a subject image which is an image representing a subject, on the basis of the subject area identified by the background/subject identification portion;

a correction portion which derives a direction of motion of a subject on the basis of the subject area identified by the background/subject identification portion, and which performs correction of the background image to create blur along the direction of motion of the subject; and

a synthesis portion which synthesizes the subject image with the background image corrected by the correction portion.

The image-shooting device of the present invention comprises the following:

an image-shooting portion which generates a plurality of burst-shot images shot successively over time; and

the aforementioned image processing device which generates a blurred-background processed image on the basis of burst-shot images generated by the image-shooting portion.

### BRIEF DESCRIPTION OF THE DRAWINGS

FIG. 1 is a block diagram depicting an overall configuration example of an image-shooting device according to an embodiment of the present invention;

FIG. 2 is a block diagram depicting a configuration example of the blurred-background processing portion of the first embodiment;

FIG. 3 is a flowchart depicting an example of operation of the blurred-background processing portion of the first embodiment;

FIG. 4 is an illustration depicting an example of burst-shot images;

FIG. 5 is an illustration depicting differential images of the burst-shot images of FIG. 4;

FIG. 6 is an illustration depicting background area identifying images of the burst-shot images of FIG. 4;

FIG. 7 is an illustration depicting subject area identifying images of the burst-shot images of FIG. 4;

FIG. 8 is an illustration depicting an example of a background map image generated from the burst-shot images of FIG. 4;

FIG. 9 is an illustration depicting an example of a subject map image generated from the burst-shot images of FIG. 4;

FIG. 10 is an illustration depicting an example of a background image generated from the burst-shot images of FIG. 4;

FIG. 11 is an illustration depicting an example of a presentation image generated from the burst-shot images of FIG. 4;

FIG. 12 is an illustration depicting an example of a subject image generated from the burst-shot images of FIG. 4;

FIG. 13 is an illustration depicting an example of motion information calculated from the subject map image of FIG. 9;

FIG. 14 is an illustration depicting an example of a filter generated on the basis of the motion information of FIG. 13;

FIG. 15 is an illustration depicting a corrected background image generated through correction of the background image of FIG. 10 using the filter of FIG. 14;

FIG. 16 is an illustration depicting a blurred-background processed image generated by synthesis of the corrected background image of FIG. 15 and the subject image of FIG. 12;

FIG. 17 is an illustration describing a first selection method example;

FIG. 18 is an illustration describing a second selection method example;

FIG. 19 is an illustration describing a third selection method example;

FIG. 20 is an illustration describing a fourth selection method example;

FIG. 21 is a block diagram depicting a configuration example of a blurred-background processing portion according to a second embodiment;

FIG. 22 is a flowchart depicting an example of operation of the blurred-background processing portion of the second embodiment;

FIG. 23 is an illustration depicting an example of the method for selecting the subject according to the subject image generation portion of the blurred-background processing portion of the second embodiment;

FIG. 24 is a block diagram depicting a configuration example of a blurred-background processing portion according to a third embodiment;

FIG. 25 is a flowchart depicting an example of operation of the blurred-background processing portion of the third embodiment; and

FIG. 26 is an illustration depicting an example of a presentation image generated by the presentation image generation portion of the blurred-background processing portion of the third embodiment.

### DETAILED DESCRIPTION OF PREFERRED EMBODIMENTS

The significance and advantages of the invention may be appreciated more clearly from the following description of the embodiments. Each of the embodiments herein merely represents one embodiment of the present invention, and the significance of the invention and of terminology for the constituent elements thereof is not limited to that taught in the following embodiments.

The description of the embodiments of the invention makes reference to the accompanying drawings. The description turns first to an image-shooting device according to an embodiment of the invention. The image-shooting device described herein is a digital camera or other device capable of recording audio, moving images, and still images.

<<Image-Shooting Device>>

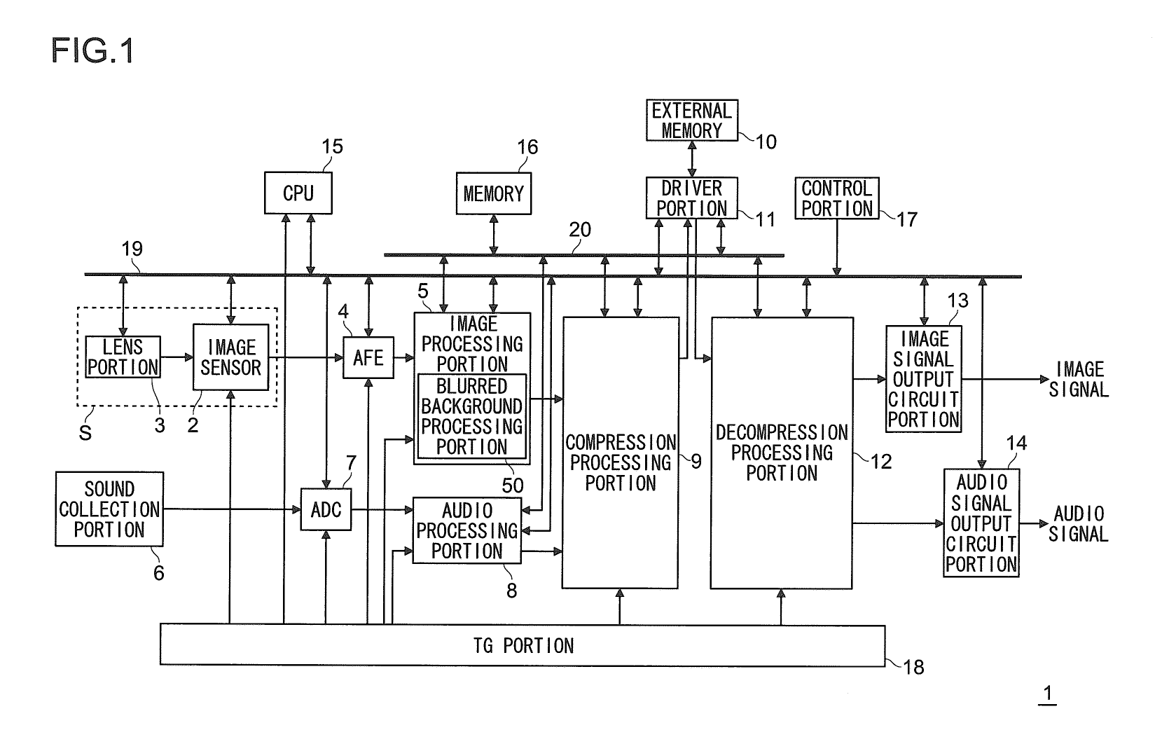

First, an overall configuration example of an image-shooting device according to an embodiment of the invention is described with reference to FIG. 1. FIG. 1 is a block diagram depicting an overall configuration example of the image-shooting device according to an embodiment of the present invention.

As shown in FIG. 1, an image-shooting device 1 includes an image sensor 2 composed of a CCD (charge coupled device) or CMOS (complementary metal oxide semiconductor) sensor, or other such solid state imaging element for converting an impinging optical image to an electrical signal; and a lens portion 3 for focusing an optical image of a subject onto the image sensor 2, as well as for adjusting the amount of light and so on. The lens portion 3 and the image portion 2 make up an image shooting portion 5, and this image shooting portion S generates an image signal. The lens portion 3 includes various lenses such as a zoom lens and a focal lens (not shown), as well as an aperture (not shown) for adjusting the amount of light entering the image sensor 2.

The image-shooting device 1 additionally includes an AFE (analog front end) 4 for converting the analog image signal output by the image sensor 2 to a digital signal, and for carrying out gain adjustment; an image processing portion 5 for carrying out various kinds of image processing, such as tone correction, on the digital image signal output by the AFE 4; a sound collection portion 6 for converting input sounds to electrical signals; an ADC (analog to digital converter) 7 for converting the analog audio signal output by the sound collection portion 6 to a digital signal; an audio processing portion 8 for carrying out various kinds of audio processing, such as denoising, on the audio signal output by the ADC 7, and for outputting the processed signal; a compression processing portion 9 for carrying out a compression coding process for motion video, such as the MPEG (Moving Picture Experts Group) compression format, respectively on the image signal output by the image processing portion 5 and the audio signal output by the audio processing portion 8, or a compression coding process for still images such as the JPEG (Joint Photographic Experts Group) compression format, on the image signal output by the image processing portion 5; an external memory 10 for recording compression coded signals compression coded by the compression processing portion 9; a driver portion 11 for recording compression coded signals to, and reading the coded signals from, the external memory 10; and a decompression process portion 12 for decompressing and decoding compression coded signals read from the external memory 10 in the driver portion 11.

The image processing portion 5 has a blurred background processing portion 50 adapted to carry out a blurred background process. In this example, a “blurred background process” refers to a process in which a plurality of sequentially shot image signals are used to generate an image signal of an image in which the subject is distinct and the background is blurred in the direction of motion of the subject. The blurred background processing portion 50 is discussed in detail later.

The image-shooting device 1 has an image signal output circuit portion 13 for converting the image signal decoded by the decompression process portion 12 to an analog signal for display on a visual display unit such as a display (not shown); and an audio signal output circuit portion 14 for converting the audio signal decoded by the decompression process portion 12 to an analog signal for playback by a playback device such as a speaker (not shown).

The image-shooting device 1 additionally includes a CPU (central processing unit) 15 for controlling overall operations inside the image-shooting device 1; a memory 16 for saving programs for carrying out various processes, as well as providing temporary storage of data during program execution; a control portion 17 for the user to input commands, such as a button for initiating shooting, buttons for adjusting shooting parameters, and the like; a timing generator (TG) portion 18 for outputting a timing control signal to synchronize operation timing of the various portions; a bus 19 for exchange of data between the CPU 15 and the various blocks; and a bus 20 for exchange of data between the memory 16 and the various blocks. For simplicity herein, mention of the buses 19, 20 is omitted when describing exchanges with the blocks.

While an image-shooting device 1 able to generate both still-image and moving-image signals is shown here by way of example, the image-shooting device 1 may be one designed to generate still-image signals only. In this case, the configuration need not include the sound collection portion 6, the ADC 7, the audio processing portion 8, or the audio signal output circuit portion 14.

The visual display unit or speaker may be integrated with the image-shooting device 1, or provided as a separate unit and connected by a cable or the like to a terminal provided to the image-shooting device 1.

The external memory 10 may be any one capable of recording image signals and audio signals. Examples of memory that can be used as the external memory 10 include semiconductor memory such as SD (secure digital) cards, optical disks such as DVDs, and magnetic disks such as hard disks. The external memory 10 may be one that is detachable from the image-shooting device 1.

Next, overall operation of the image-shooting device 1 is described using FIG. 1. First, the image-shooting device 1 acquires an image signal, which is an electrical signal, through photoelectric conversion of light impinging on the lens portion 3 taking place in the image sensor 2. The image sensor 2 then outputs the image signal to the AFE 4 at prescribed timing in synchronization with a timing control signal input from the TG portion 18.

Then, the image signal, which has been converted from an analog signal to a digital signal by the AFE 4, is input to the image processing portion 5. In the image processing portion 5, the input image signal composed of R (red), G (green), and B (blue) components is converted to an image signal composed of luminance signal (Y) and color difference signals (U, V) components, and also undergoes various kinds of image processing such as tone correction and edge sharpening. The memory 16 operates as frame memory, temporarily holding the image signal while processing by the image processing portion 5 is taking place.

On the basis of the image signal input to the image processing portion 5 at this time, in the lens portion 3 the positions of the various lenses are adjusted in order to adjust the focus, and the opening of the aperture is adjusted in order to adjust the exposure. Adjustment of focus and exposure may be accomplished automatically on the basis of a prescribed program designed to make optimal settings for each, or performed manually based on user commands.

In certain prescribed instances (e.g. when the user selects a mode to carry out a blurred background process), the blurred background processing portion 50 carries out a blurred background process using a plurality of image signals input to the image processing portion 5, and outputs a processed image signal.

In the event that a moving-image signal is to be generated, sound collection is performed by the sound collection portion 6. The audio signal created through sound collection by the sound collection portion 6 and conversion to an electrical signal is input to the audio processing portion 8. The audio processing portion 8 then converts the input audio signal to a digital signal, and well as carrying out various types of audio processing such as denoising and audio signal strength control. The image signal output by the image processing portion 5 and the audio signal output by the audio processing portion 8 are then both input to the compression processing portion 9, and in the compression processing portion 9 are compressed with a prescribed compression format. At this time, the image signal and the audio signal are associated chronologically so that the video and sound will not be out of sync during playback. The compression encoded signal output by the compression processing portion 9 is then recorded to the external memory 10 via the driver portion 11.

On the other hand, if a still-image signal is to be generated, the image signal output by the image processing portion 5 is input to the compression processing portion 9, and in the compression processing portion 9 is compressed with a prescribed compression format. The compression encoded signal output by the compression processing portion 9 is then recorded to the external memory 10 via the driver portion 11.

The moving image compression encoded signal recorded to the external memory 10 is read out to the decompression process portion 12 through a user command. The decompression process portion 12 decompresses and decodes the compression encoded signal to generate an image signal and an audio signal for output. The image signal output circuit portion 13 converts the image signal output by the decompression process portion 12 to a format that can be displayed on the visual display unit and outputs the signal, while the audio signal processing circuit portion 14 converts the audio signal output by the decompression process portion 12 to a format that can be played back through the speaker and outputs the signal. A still image compression encoded signal recorded to the external memory 10 undergoes processing analogously. Specifically, the decompression process portion 12 decompresses and decodes the compression encoded signal to generate an image signal, and the image signal output circuit portion 13 converts the image signal to a format that can be played back on the visual display unit and outputs the signal.

In so-called preview mode, which allows the user to check images for display on a visual display unit or the like without having to record the image signal, the image signal output by the image processing portion 5 may be output without compression to the image signal output circuit portion 13. During recording of an image signal, the image signal may be output to a visual display unit or the like via the image signal output circuit portion 13 in an operation parallel with compression by the compression processing portion 9 and recording to the external memory 10.

### <<Blurred Background Processing Portion>>

Next, a detailed description of the blurred background processing portion 50 mentioned above is provided through examples of three embodiments, with reference to the drawings for each. For the purpose of providing a more specific description, the image signals processed by the blurred background processing portion 50 are represented as being images. In particular, each of a plurality of image signals obtained in burst-shot mode and input to the blurred background processing portion 50 are termed “burst-shot images”. An image signal generated through blurred background processing portion is termed a “background blur processed image”.

### First Embodiment

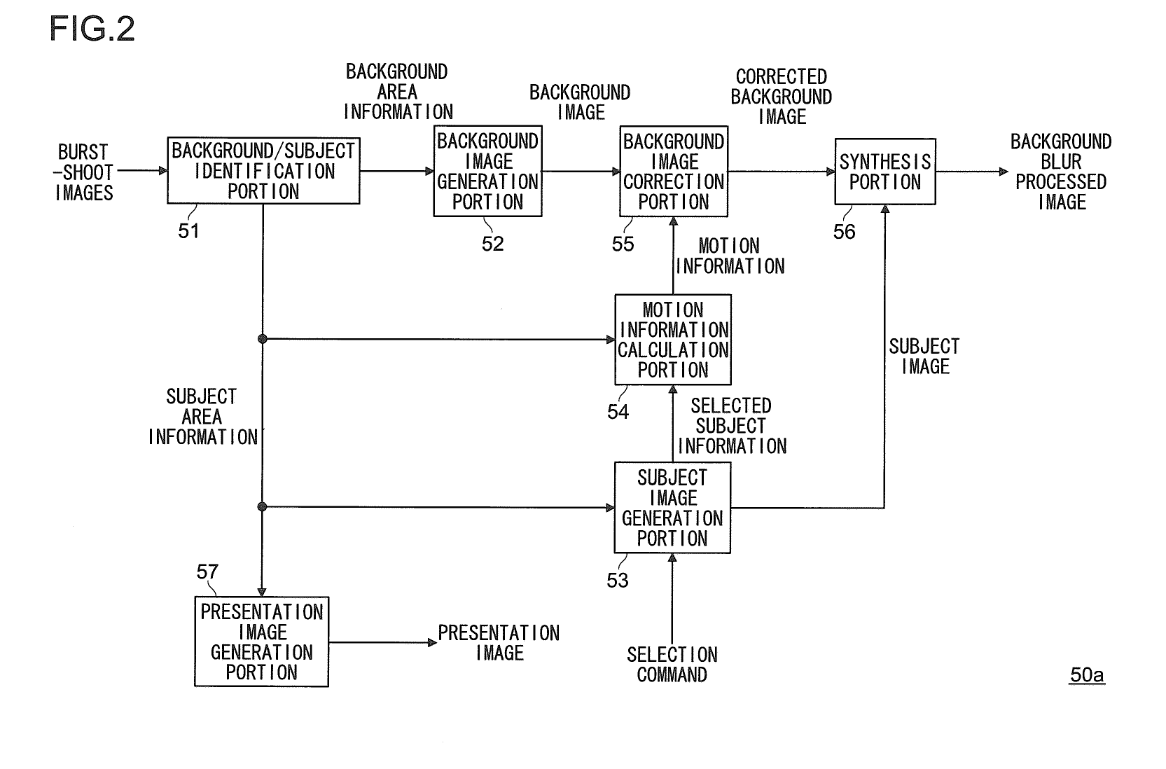

The description turns first to a first embodiment of the blurred background processing portion, with reference to the drawings. FIG. 2 is a block diagram depicting a configuration example of the blurred-background processing portion of the first embodiment.

As shown in FIG. 2, the blurred background processing portion 50a has a background/subject identification portion 51 for respectively identifying in a plurality of burst-shot images a background area representing the background and a subject area representing the subject, and for outputting background area information and subject area information; a background image generation portion 52 for generating and outputting a background image, which is an image representing a background, on the basis of background area information output by the background/subject identification portion 51; a subject image generation portion 53 for selecting a subject for synthesis and outputting selected subject information, as well as for generating and outputting a subject image which is an image representing the selected subject, on the basis of the subject area information output by the background/subject identification portion 51; a motion information calculation portion 54 for calculating and outputting motion information for a subject on the basis of subject area information output by the background/subject identification portion 51 and selected subject information output by the subject image generation portion 53; a background image correction portion 55 for performing correction on the background image output by the background image generation portion 52, based on the motion information output by the motion information calculation portion 54, and for outputting the image; a synthesis portion 56 for synthesizing the subject image output by the subject image generation portion 53 with the corrected background image output by the background image correction portion 55, to generate a background blur processed image; and a presentation image generation portion 57 for generating and outputting a presentation image which is an image for presentation to the user, on the basis of subject area information output by the background/subject identification portion 51.

The subject image generation portion 53 selects subjects on the basis of a selection command (a command by the user to select a subject for synthesis, input via the control portion 17 etc.), or selects subjects for synthesis automatically based on a prescribed selection method (program). Where the subject image generation portion 53 only selects subjects for synthesis automatically, a configuration that does not provide for input of selection commands to the subject image generation portion 53 is acceptable.

Background area information refers to information indicating the position of the background area within burst-shot images, an image of the background area (e.g. pixel values), or the like. Similarly, subject area information refers to information indicating the position of the subject area within burst-shot images, an image (e.g. pixel values), or the like. The subject area information input to the subject image generation portion 53, the motion information calculation portion 54, and the presentation image generation portion 57 may be the same or different.

Motion information is information relating to motion of the subject. Examples are information indicating the direction of motion or extent of motion (which may also be interpreted as speed) of the subject. Selected subject information is information indicating which subject was selected in the subject image generation portion 53, or which burst-shot images include the subject.

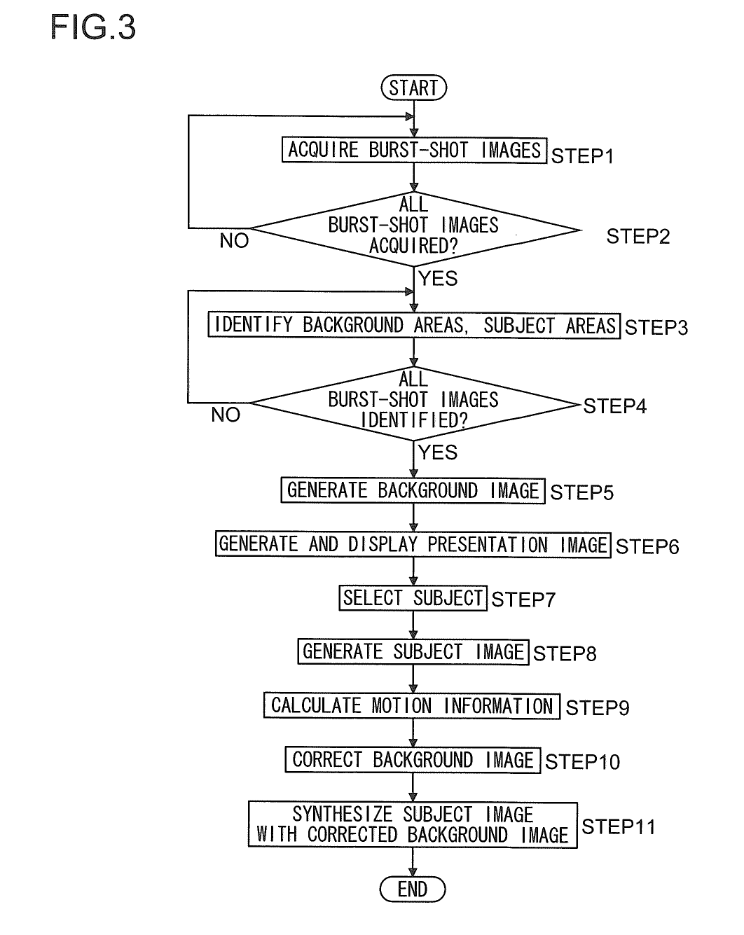

An example of operation of the blurred background processing portion 50a shall now be described with reference to the drawings. FIG. 3 is a flowchart depicting an example of operation of the blurred-background processing portion of the first embodiment. The following description also touches upon operation of parts in relation to the blurred background process of the image-shooting device 1 shown in FIG. 1, in addition to that of the blurred background processing portion 50a.

As shown in FIG. 3, when the blurred background processing portion 50 initiates operation, it first acquires burst-shot images (STEP 1). The burst-shot images are generated through burst shooting at prescribed timing (discussed in detail later) by the shooting portion S under control by the CPU 15. The blurred background processing portion 50 acquires burst-shot images in succession (STEP 1) until all of the burst-shot images needed for the blurred background process are acquired (STEP 2, NO).

Once the blurred background processing portion 50a has acquired all of the burst-shot images (STEP 2, YES), the background/subject identification portion 51 identifies the background area and the subject area of the acquired burst-shot images (STEP 3). The background/subject identification portion 51 carries out successive identification (STEP 3) until the background area and the subject area have been identified for each of the acquired burst-shot images (STEP 4, NO).

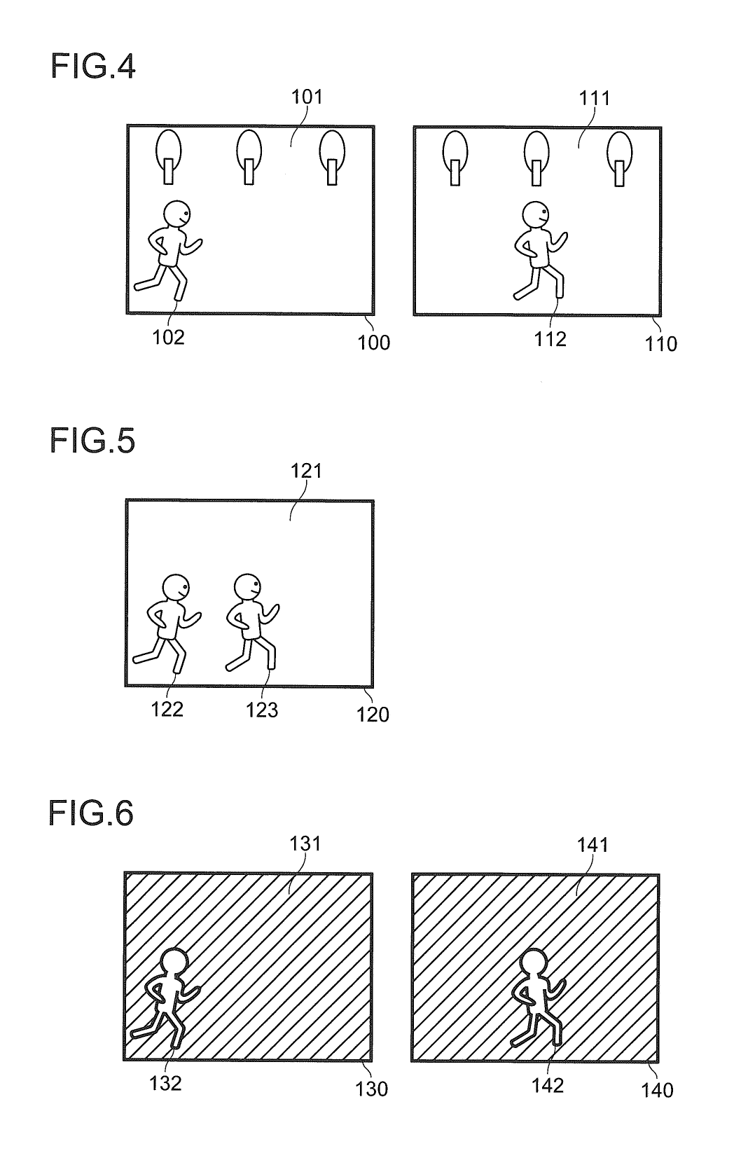

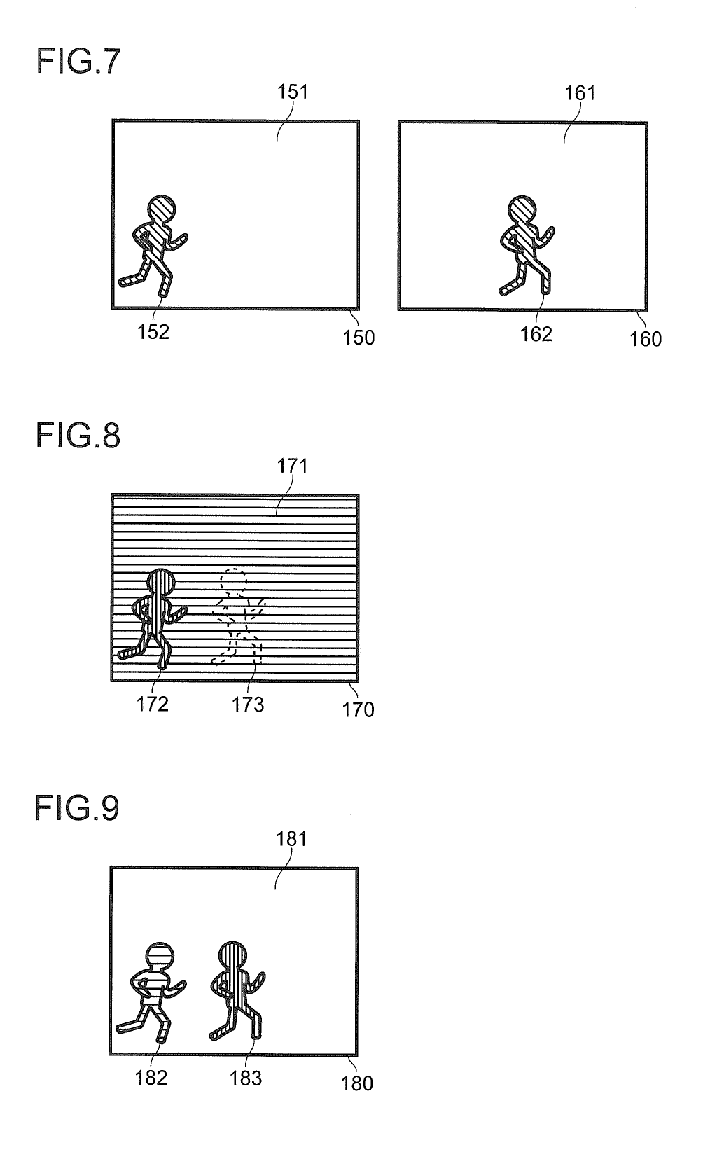

An example of the identification method is described with reference to FIGS. 4 to 7. FIG. 4 is an illustration depicting an example of burst-shot images; FIG. 5 is an illustration depicting differential images of the burst-shot images of FIG. 4; FIG. 6 is an illustration depicting background area identifying images of the burst-shot images of FIG. 4; and FIG. 7 is an illustration depicting subject area identifying images of the burst-shot images of FIG. 4. For the purposes of specific description, an example of an instance in which background areas 101, 111 representing the area other than a human subject, and subject areas 102, 112 representing a human who is the subject, are identified respectively in two burst-shot images 100, 110 shown in FIG. 4.

The burst-shot image 100 shown in FIG. 4 is one shot previously in time (e.g. immediately prior to) the burst-shot image 110, and the subject area 102 is positioned to the left side in the burst-shot image 100. Meanwhile, in the burst-shot image 110, the subject area 112 is positioned at the approximate center. It is assumed that the burst-shot images 100, 110 were shot by the image-shooting device 1 while fixed on a tripod or the like, so that the image-shooting device 1 did not move during shooting of the burst-shot images 100, 110 (i.e. there is no shift of background between the burst-shot images 100, 110).

The differential of the burst-shot images 100, 110 of FIG. 4 are derived to obtain the differential image 120 shown in FIG. 5. In the differential image 120, absolute values of pixel values (differential values) of areas 122, 123 corresponding respectively to the subject areas 102, 112 of the burst-shot images 100, 110 (for simplicity in description, these areas are also termed subject areas) are large, while pixel values of the background area 121 are small. Thus, through recognition of pixel values of the differential image 120, the background areas 101, 111 and the subject areas 102, 112 may be respectively identified in the burst-shot images 100, 110. However, it is necessary to determine whether the subject areas 122, 123 that were identified in the differential image 120 respectively correspond to the subject areas 102, 112 in each of the burst-shot images 100, 110.

This determination may be made for example by comparing the differential image 120 with the respective burst-shot images 100, 110 (e.g. for the respective burst-shot images 100, 110, verifying that pixel values of areas respectively corresponding to the subject areas 122, 123 in the differential image 120 differ from surrounding pixel values). It is possible thereby to identify the subject areas 102, 112 for the respective burst-shot images 100, 110. Conversely, it is possible to identify the background areas 101, 111 in the respective burst-shot images 100, 110.

While the preceding example describes an instance where there are two burst-shot images, multiple differential images may be generated in instances of three or more. Where generation of multiple differential images is possible, background areas and subject areas of the respective burst-shot images may be identified simply by comparing the subject areas identified in the respective differential images.

To give a specific example, a subject area common to two differential images generated from three burst-shot images may be identified as a subject area common to the burst-shot images used to generate the two differential images. On the other hand, a subject area that is not common to two differential images may be identified as a subject area not common to the burst-shot images used to generate the respective differential images.

It is possible for the results of identification described above to be represented as the background area identifying images 130, 140 depicted in FIG. 6 or as the subject area identifying images 150, 160 depicted in FIG. 7. The background area identifying images 130, 140 depicted in FIG. 6 are created by distinguishing between the pixel values for the background areas 131, 141 (e.g. 1) and the pixel values for the subject areas 132, 142 (e.g. 255). Similarly, the subject area identifying images 150, 160 depicted in FIG. 7 are created by distinguishing between the pixel values for the background areas 151, 161 (e.g. 255) and the pixel values for the subject areas 152, 162 (e.g. 1). It is possible to dispense with generating either the background area identifying images 130, 140 or the subject area identifying images 150, 160 need not take place, or to dispense with generating both.

Based on the identification results discussed above, a background map image may be generated. The background map image is described with reference to FIG. 8. FIG. 8 is an illustration depicting an example of a background map image generated from the burst-shot images of FIG. 4. While postponing detailed discussion for later, the blurred background processing portion 50a of the present example uses the burst-shot images 100, 110 to generate an image displaying only the background but neither of the subject areas 102, 112 (background image). However, each of the burst-shot images 100, 110 in the present example includes a subject area 102, 112. Thus, the burst-shot images 100, 110 are combined to remove the subject areas 102, 112 and generate the background image. For each pixel of the background image, the background map image 170 shown in FIG. 8 represents by a pixel value whether the pixel value of the burst-shot image 100 or 110 should be used.

As a specific example, in the background map image 170 shown in FIG. 8, the pixel values (e.g. 1) for the area 171 in which the pixel values of the burst-shot image 100 are used (the area corresponding to the background area 101 of the burst-shot image 100, indicated by horizontal lines in the drawing) are distinguished from the pixel values (e.g. 255) for the area 172 in which the pixel values of the burst-shot image 110 are used (the area corresponding to the subject area 102 of the burst-shot image 100, indicated by vertical lines in the drawing). While the pixel values of the burst-shot image 100 are primarily used (pixel values of the burst-shot image 110 are used as pixel values only in the area 172 for which pixel values of the burst-shot image 100 cannot be used, while pixel values of the burst-shot image 100 are used in other areas), it would be acceptable instead to primarily use pixel values of the burst-shot image 110 (to use pixel values of the burst-shot image 100 as pixel values only in the area 173 for which pixel values of the burst-shot image 110 cannot be used, while using pixel values of the burst-shot image 110 for other areas). For areas in which pixel values of both of the burst-shot images 100, 110 may be used (areas other than the areas 172 and 173), weighted sums of pixel values of the burst-shot images 100, 110 may be used, or pixel values of the burst-shot images 100, 110 different from neighboring pixels may be used.

Based on the identification results discussed above, it is possible to generate a subject map image. A subject image map is described with reference to FIG. 9. FIG. 9 is an illustration depicting an example of a subject map image generated from the burst-shot images of FIG. 4.

The subject map image 180 shown in FIG. 9 includes within a single image areas 182, 183 that correspond respectively to the subject areas 102, 112 of the burst-shot images 100, 110 (for simplicity in description, these areas are also called subject areas), while distinguishing among pixel values for the respective subject areas 182, 183. The subject map image 180 represents the positions of the subject areas 102, 112 in the plurality of burst-shot images 100, 110, through pixel values of a single image.

To give a specific example, in subject map image 180 shown in FIG. 9, pixel values (e.g. 1) of the subject area 182 which corresponds to the subject area 102 of the burst-shot image 100 (the area represented by horizontal lines in the drawing) are distinguished from pixel values (e.g. 255) of the subject area 183 which corresponds to the subject area 112 of the burst-shot image 110 (the area represented by vertical lines in the drawing). The area 181 excluding the subject areas 182, 183 may be assigned any pixel value (e.g. 0) such that it may be distinguished from the subject areas 182, 183.

The background area identifying images 130, 140 which indicate positions of background areas, the background map image 170, or the burst-shot images 100, 110 containing the images of the background areas 101, 111 may be included in the background area information. Images obtained by extraction of images of the background areas 101, 111 from the burst-shot images 100, 110 (e.g. images in which pixel values of the subject areas 102, 112 of the burst-shot images 100, 110 are assigned prescribed values such as 0) or the like may likewise be included in the background area information.

Similarly, the subject area identifying images 150, 160 which indicate positions of subject areas, the subject map image 180, or the burst-shot images 100, 110 containing images of the subject areas may be included in the subject area information. Images obtained by extraction of images of the subject areas 102, 112 from the burst-shot images 100, 110 (e.g. images in which pixel values of the background areas 101, 111 of the burst-shot images 100, 110 are assigned prescribed values such as 0, i.e. images similar to the subject images to be discussed later) or the like may likewise be included in the subject area information.

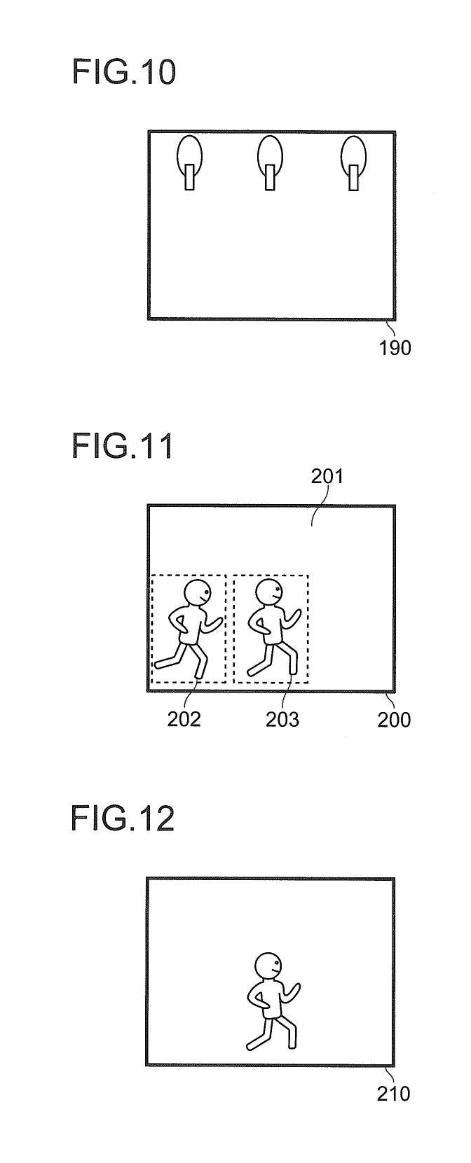

As described above, once the background/subject identification portion 51 has identified the background areas 101, 111 and the subject areas 102, 112 for the respective burst-shot images 100, 110 and has output the background area information and the subject area information (STEP 4, YES), next, the background image generation portion 52 generates a background image on the basis of the background area information (STEP 5). An example of a background image so generated is described with reference to FIG. 10. FIG. 10 is an illustration depicting an example of a background image generated from the burst-shot images of FIG. 4.

The background image 190 shown in FIG. 10 may be generated using the burst-shot images 100, 110 (and particularly their respective background areas 101, 111) in the manner described above. It is preferable to refer to the background map image 170 during generation of the background image 190, as by doing so it is possible to readily decide which burst-shot image 100, 110 pixel values to use as particular pixel values in the background image 190. Reference may be made to the background area identifying images 130, 140 in addition to the background map image 170, when generating the background image 190.

The presentation image generation portion 57 generates and outputs a presentation image on the basis of subject area information output by the background/subject identification portion 51. The output presentation image is input, for example, to the image signal output circuit portion 13 via the bus 19, and is displayed on a visual display unit or the like (STEP 6).

An example of a presentation image is shown in FIG. 11. FIG. 11 is an illustration depicting an example of a presentation image generated from the burst-shot images of FIG. 4. The presentation image 200 of the present example shows images of the subject areas 102, 112 of the burst-shot images 100, 110, displayed respectively in areas 202, 203 that correspond to the respective subject areas 102, 112 of the burst-shot images 100, 110 (for simplicity in description, these areas are also called subject areas). For the purpose of clearly indicating that the respective subject areas 202, 203 of the presentation image 200 represent images of the subject areas 102, 112 in different burst-shot images 100, 110, the subject areas 202, 203 may be provided with border lines (shown by broken lines in the drawing) or the like. Pixel values of the area 201 other than the subject areas 202, 203 in the presentation image 200 may be assigned prescribed values such as 0, or pixel values of the background image 190 may be used (in this case, the presentation image generation portion 57 would acquire the background area information or the background image).

The presentation image 200 may be generated using the burst-shot images 100, 110. During generation of this presentation image 200, it is preferable to refer to the subject map image 180, as by doing so it may be readily decided which burst-shot image 100, 110 pixel values to employ for pixels at which positions. The format of the presentation image 200 shown in FIG. 11 is merely exemplary, and other formats are possible. As an example, images respectively obtained through extraction of the images of the subject areas 102, 112 from the burst-shot images 100, 110 are reduced in size, and the images are lined up in the presentation image.

The user checks the displayed presentation image 200, and selects a subject for synthesis (a subject shown in the presentation image 200, i.e. a subject displayed in either subject area 102, 112 of the burst-shot images 100, 100) (STEP 7). At this time, a selection command indicating which subject has been selected is input to the subject image generation portion 53 through user operation of the control portion 17 for example.

The subject image generation portion 53 then generates a subject image, i.e. an image representing the subject that was selected based on the selection command (STEP 8), and outputs selected subject information indicating the subject in question. For the purpose of more specific description, it is assumed that the subject image generation portion 53 has selected the subject that is shown in the subject area 112 of the burst-shot image 110.

An example of the subject image generated at this time is described with reference to FIG. 12. FIG. 12 is an illustration depicting an example of a subject image generated from the burst-shot images of FIG. 4. The subject image 210 shown in FIG. 12 is one obtained by extraction of an image of the subject area 112 of the burst-shot image 110. An example is an image in which the pixel values of the background area 111 of the burst-shot image 110 have been assigned prescribed values such as 0.

In the above manner, it is possible for the subject image generation portion 53 to select a subject for synthesis automatically, based on a prescribed selection method. In this case, the presentation image generation portion 57 and STEP 6 may be unnecessary, or the system may be redesigned so that presentation image generation portion 57 generates a presentation image for confirmatory presentation of the selected subject to the user. Methods whereby the subject image generation portion 53 selects the subject automatically are discussed in detail later.

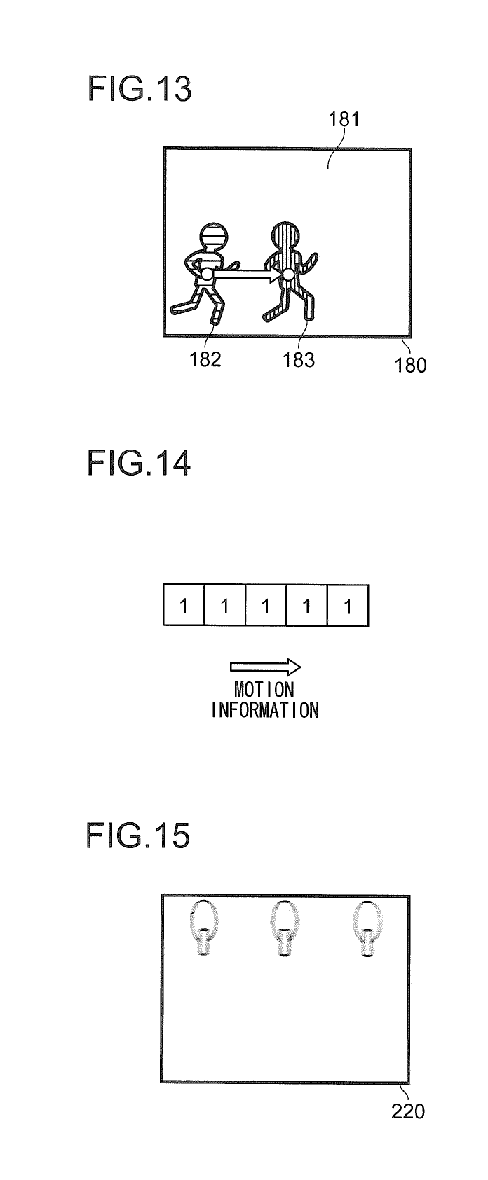

The motion information calculation portion 54 recognizes the selected subject (or burst-shot images containing the subject) on the basis of the selected subject information output from the subject image generation portion 53. The motion information calculation portion 54 then calculates motion information for the selected subject based on the selected subject information (STEP 9). An example of this calculation method is described with reference to FIG. 13. FIG. 13 is an illustration depicting an example of motion information calculated from the subject map image of FIG. 9.

The motion information shown in FIG. 13 (the white arrow in the drawing) may be calculated by comparing the respective subject areas 182, 183 with different pixel values of the subject map image 180. Specifically, the direction (the direction of the white arrow in the drawing) connecting the centers of gravity of the subject images 182, 183 (the white circles in the drawing) may be calculated as the direction of motion, and the distance between the centers of gravity (linear distance, or respective distances in the horizontal and vertical directions) may be calculated as the extent of motion.

In the present example, because there are two burst-shot images 100, 110, motion information for the subject selected by the subject image generation portion 53 may be calculated simply by comparing the two subject areas 182, 183. However, cases may arise in which there are three or more burst-shot images and subject areas.

In such cases, motion information for a selected subject may be calculated accurately and easily using the subject map image for example, through comparison of a subject area showing the position of the subject selected by the subject image generation portion 53 with a subject area showing the position of the subject contained in a burst-shot image shot temporally before or after (e.g. immediately before or immediately after) a burst-shot image containing the selected subject. Motion information for a selected subject may also be calculated through respective comparisons of a subject area showing the position of a selected subject, with subject areas showing the position of the subject contained in burst-shot images respectively shot temporally before and after (e.g. immediately before and immediately after) the burst-shot image containing the selected subject, to arrive at two sets of calculated motion information which are then averaged.

The motion information calculation portion 54 is not limited to the subject map image 180, and may instead calculate motion information for a subject selected by the subject image generation portion 53, based on images or information from which the positions of subject areas may be discriminated, such as the subject area identifying images 150, 160.

Once motion information for a subject selected by the subject image generation portion 53 has been calculated and output by the motion information calculation portion 54, on the basis of this motion information, the background image correction portion 55 performs correction of the background image 190 output by the background image generation portion 52 (STEP 10). One example of this correction process is described with reference to FIGS. 14 and 15. FIG. 14 is an illustration depicting an example of a filter generated on the basis of the motion information of FIG. 13. FIG. 15 is an illustration depicting a corrected background image generated through correction of the background image of FIG. 10 using the filter of FIG. 14.

In the correction method of the present example, as shown in FIG. 14, a filter 190 adapted to average the pixel values of pixels lined up along the direction of motion of the subject (the left to right direction in the drawing) is applied to the background image 190. It is possible thereby to obtain the corrected background image 190 like that shown in FIG. 15, having blur in the direction of motion of the subject.

As one example of the above filter, FIG. 14 depicts a filter for averaging the pixel values of a total of five pixels, i.e. a target pixel and two pixels to left and to the right thereof respectively, to obtain a pixel value for the corrected target pixel. The filter shown in FIG. 14 is merely one example, and other filters may be used. For example, where the direction of motion of the subject is the left to right direction as depicted in FIG. 13, it would be acceptable to use a filter that averages not just pixel values of pixels arrayed to the left and right directions of the target pixel, but also those in the vertical direction, to obtain a pixel value for the corrected target pixel.

Further, it is preferable to adjust the filter applied to the background image 190 on the basis of the extent of motion of the subject, as by doing so it is possible to better carry out correction of the background image 190 to reflect the extent of motion of the subject. As a specific example, the number of pixels that are averaged along the direction of motion may be increased to reflect a greater extent of motion of the subject (i.e. the filter size may be increased along the direction of motion). By doing so it is possible to increase the degree of blur of the background image 190 to reflect greater extent of motion of the subject.

The synthesis portion 56 then synthesizes the subject image 210 generated by the subject image generation portion 53, with the background image 220 obtained through correction by the background image correction portion 55 (STEP 11). For example, pixel values of an area corresponding to the subject area 112 of the background image 220 are replaced by pixel values of the subject image 210. A background blur processed image is thereby generated, and the blurred background processing portion 50a operation terminates.

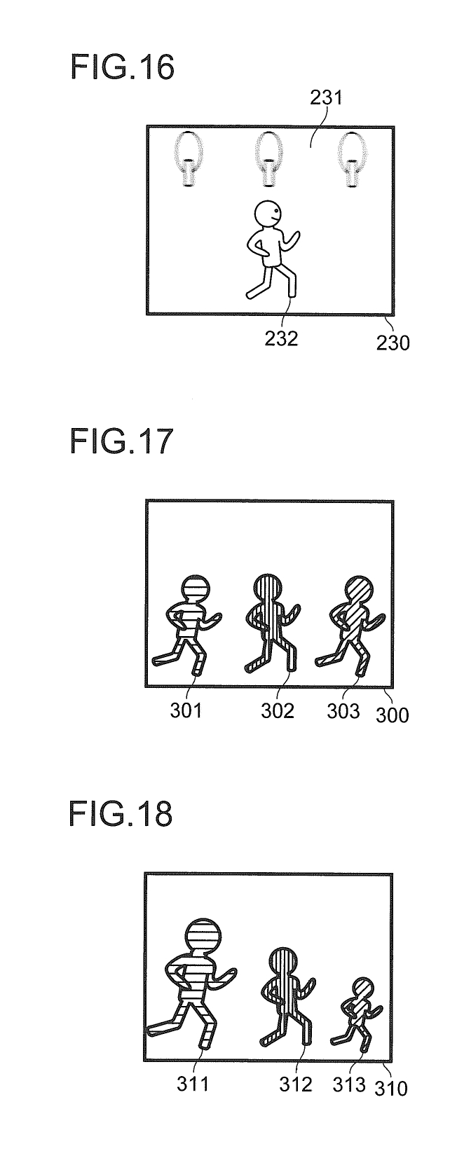

An example of such a background blur processed image is described with reference to FIG. 16. FIG. 16 is an illustration depicting a blurred-background processed image generated by synthesis of the corrected background image of FIG. 15 and the subject image of FIG. 12. As shown in FIG. 16, in the background blur processed image 230 obtained by the operation described above, the background (the area 231) is blurred along the direction of motion of the subject, whereas the subject (the area 232) is distinct.

Where configured in the above manner, the background image 190 is generated using the background areas 101, 111 of the burst-shot images 100, 110, and the subject image 210 is generated using the subject area 112. Thus, during generation of the background image 190, the need to separately shoot an image not containing the subject is avoided. Specifically, it is possible to minimize instances of generating background images in which background conditions or shooting environment differ from the burst-shot images 100, 110. It is accordingly possible to generate background blur processed images in which the subject is distinct, and the subject and background are synthesized without noticeable inconsistency.

Also, the background/subject identification portion 51 derives the differential of the burst-shot images 100, 100, thereby respectively identifying the background areas 101, 111 and the subject areas 102, 112. Thus, it is possible to identify the respective areas easily and effectively.

The background image correction portion 55 corrects the background image 190 based on the motion information for the subject represented by the subject image 210. Thus, it is possible to approximately align the direction of motion of the subject contained in the background blur processed image 230, and the direction of blur of the background.

In preferred practice, in order to accurately identify the background areas 101, 111 and the subject areas 102, 112, the image-shooting device 1 is fixed on a tripod or the like when the burst-shot images 100, 110 are shot, as mentioned previously. However, it is possible to identify the background areas 101, 111 and the subject areas 102, 112 even in instances in which the image-shooting device 1 is not fixed (for example, when the user shoots the images while holding the image-shooting device 1).

For example, using known methodology such as representative point matching or block matching, correspondences between given pixels in a given burst-shot image and pixels in another burst-shot image are detected to derive the extent of shift between the burst-shot images, and a process such as one to convert the coordinates of the burst-shot images to correct the shift is carried out, making it possible to accurately identify background areas and subject areas even if the image-shooting device 1 is not fixed.

Also, the background image generation portion 52 may acquire selected subject information, and generate a background image according to the selected subject. For example, the background image generation portion 52 may generate a background image using primarily pixel values of burst-shot images containing the selected subject.

The presentation image 210 of FIG. 12 displays images of the subject areas 102, 112 of the burst-shot images 100, 110, but may instead display positions of the subject, as in the subject map image 180. The flowchart shown in FIG. 3 is merely one example, and it is possible to rearrange the order of the respective operations (STEPS) if no conflicts would arise from doing so.

(Burst-Shot Image Shooting Timing)

If the section in which the subject areas 102, 112 in the burst-shot images 100, 110 are in an identical position (in which the subject areas 102, 122 overlap in the differential image 120) is large, it may be difficult to identify the background images 101, 111 and the subject areas 102, 112. Thus, it is preferable for the CPU 15 to control the shooting timing by the shooting portion S, such that the time interval at which the burst-shot images 100, 110 are respectively shot is not excessively short in relation to the extent of motion of the subject.

As a specific example, the extent of motion of the subject may be calculated on the basis of images shot during preview mode prior to shooting the burst-shot images 100, 110, and the image-shooting timing controlled such that when the burst-shot images 100, 110 are shot at the extent of motion in question, the time interval is one that is intended to eliminate (or minimize) sections in which the subject areas have identical position.

Where the shooting timing is controlled as in the above example, the extent of motion of the subject during preview mode may be calculated by any method. For example, during preview mode, image characteristics (e.g. a component indicating color of pixel values (where pixel values are represented by H (hue), S (saturation), and V (value), the H component or the like)) of a subject selected by the user through the control portion 17 (e.g. a touch panel or cursor key) or a subject selected on the basis of a prescribed program (e.g. one that detects a section similar to a sample (an unspecified face, a specified face, etc.) from within the image) may be detected from sequentially shot images (i.e. carrying out a tracking process), to calculate the extent of motion of the subject.

(Automatic Selection of Subject)

As mentioned above, the subject image generation portion 53 may be configured such that the subject for synthesis is selected automatically. Several examples of subject selection methods are described below with reference to the drawings. The selection methods described below may be carried out concomitantly where no conflicts would arise from doing so. For example, each subject may be evaluated as to whether to the subject should be selected based on the respective selective methods, and the subject for synthesis then selected on the basis of comprehensive evaluation results obtained through weighted addition of these evaluation results.

### First Selection Method Example

FIG. 17 is an illustration describing a first selection method example. The first selection method example involves selecting the subject for synthesis on the basis of the position of the subject within the angle of view (the position of the subject area in the burst-shot image). For example, a subject in proximity to a prescribed position in the angle of view (a subject area in proximity to a prescribed position in the burst-shot image) is selected. This selection method may be carried out on the basis of the subject map image 300 as shown in FIG. 17, or carried out on the basis of the subject area identification images, or images obtained by extracting an image of the subject area from burst-shot images. However, selection on the basis of the subject map image 300 is preferred, because the subject for synthesis can be easily selected based on a single image.

For example, in the subject map image 300 shown in FIG. 17, in the event that a subject close to the center of the angle of view (the subject area close to the center of the burst-shot image) is selected, the subject shown by the subject area 302 would be selected as the subject for synthesis from among the subject areas 301 to 303.

The positions of the respective subjects may be designated to be the respective positions of the center of gravity of the subject areas 301 to 303. Alternatively, a series of movements of the subject may serve as the criterion, rather than the angle of view serving as the criterion. For example in a series of movements of the subject, the subject in proximity to the center position of movement may be selected. At this time, selection of the subject may take place based on motion information calculated for all subjects (the details are discussed in the second embodiment of the blurred background processing portion), or selection may take place with an area enclosing the subject areas 301 to 303 (i.e. the area of motion of the subject) as the criterion.

### Second Selection Method Example

FIG. 18 is an illustration describing a second selection method example. The second selection method example involves selecting the subject for synthesis on the basis of the size of the subject (the subject area as a proportion of the burst-shot image). For example, a subject area whose proportion of the angle of field is close to a prescribed size (a subject area whose proportion of the burst-shot image is close to a prescribed size) is selected. This selection method may be carried out on the basis of the subject map image 310 as shown in FIG. 18, or carried out on the basis of the subject area identification images, or images obtained by extracting an image of the subject area from burst-shot images. However, selection on the basis of the subject map image 310 is preferred, because the subject for synthesis can be easily selected based on a single image.

In the subject map image 310 shown in FIG. 18, in the event that the largest subject (the subject area representing the largest proportion of the burst-shot image) is selected, the subject shown by the subject area 311 would be selected as the subject for synthesis from among the subject areas 311 to 313. Likewise, in the event that a subject of medium size is selected, the subject shown by the subject area 312 would be selected.

The size of respective subjects may be ascertained from the respective pixel counts of the subject areas 301 to 303. With such a configuration, the size of subjects can be ascertained easily. The respective subject sizes may also be ascertained in terms of size of respective areas (e.g. rectangular areas) enclosing the subject areas 301 to 303.

### Third Selection Method Example

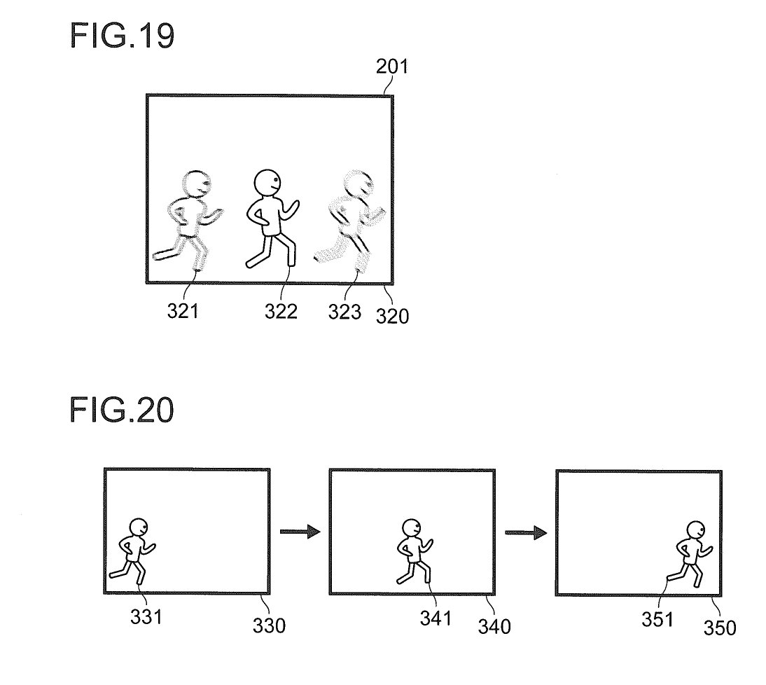

FIG. 19 is an illustration describing a third selection method example. The third selection method example involves selecting the subject for synthesis on the basis of an image characteristic of the subject (the pixel values of the subject area of the burst-shot image). For example, a subject with high sharpness (the subject area with high sharpness in the burst-shot image) is selected. As shown in FIG. 19, this selection method may be carried out on the basis of an image 320 produced by extracting images of the subject area from respective burst-shot images and displaying these together. The image is comparable to the presentation image 200 shown in FIG. 11, and may be created for example by extracting pixel values of subject areas from the respective burst-shot images with reference to the subject map image. The selection method of the present example may also be carried out based on respective images obtained through extraction of images of the subject area from burst-shot images.

In the image 320 shown in FIG. 19, in the event that the subject with the highest sharpness (the image of the subject area of highest sharpness in the burst-shot image) is selected, the subject shown by the subject area 322 would be selected as the subject for synthesis from among the subject areas 321 to 323.

Sharpness of respective images may be calculated on the basis of the high frequency component of pixel values of pixels in the subject areas 321 to 323, contrast, saturation, or the like. In this case, a greater high frequency component, higher contrast, or higher saturation would be considered to have greater sharpness.

For example, a higher sum or average of edges, as determined through application of a differential filter or the like to the pixels of the subject areas 321 to 323, corresponds to a larger high frequency component. Or, for example, a larger difference between the maximum value and minimum value of the component representing luminance or hue of pixel values of the subject areas 321 to 323 (the Y component where pixel values are represented by YUV, or the S component where represented by HSV) corresponds to a higher contrast. Or, for example, where pixel values are represented by HSV, a larger S component would correspond to higher saturation.

### Fourth Selection Method Example

FIG. 20 is an illustration describing a fourth selection method example. The fourth selection method example involves selecting the subject for synthesis based on the sequence in which a subject was shot. For example, among respective subjects shown by subject areas identified in burst-shot images, one shot in a prescribed sequence may be selected. The selection method may be carried out, for example, by checking the sequence (and if necessary the total number as well) of burst-shot images shot of subject areas identified by the background/subject identification portion 51. The selection method may be carried out based on the subject map image as well, because the shooting sequence can be ascertained from the pixel values of the subject areas.

FIG. 20 depicts respective burst-shot images 330, 340, 350 in which subject areas 331, 341, 351 have been identified. In FIG. 20, the burst-shot image 300 (the subject area 331) is the image shot first in a given time period, and the burst-shot image 350 (the subject area 351) is the one shot last. At this time, in the event that the subject shot at a chronological midpoint from among the subjects shown by the subject areas 331, 341, 351 respectively identified in the burst-shot images 330, 340, 350 is selected, the subject shown by the subject area 341 would be selected as the subject for synthesis.

The subject for synthesis may also be selected based on the shooting sequence of burst-shot images (including those in which no subject area is identified).

### Second Embodiment

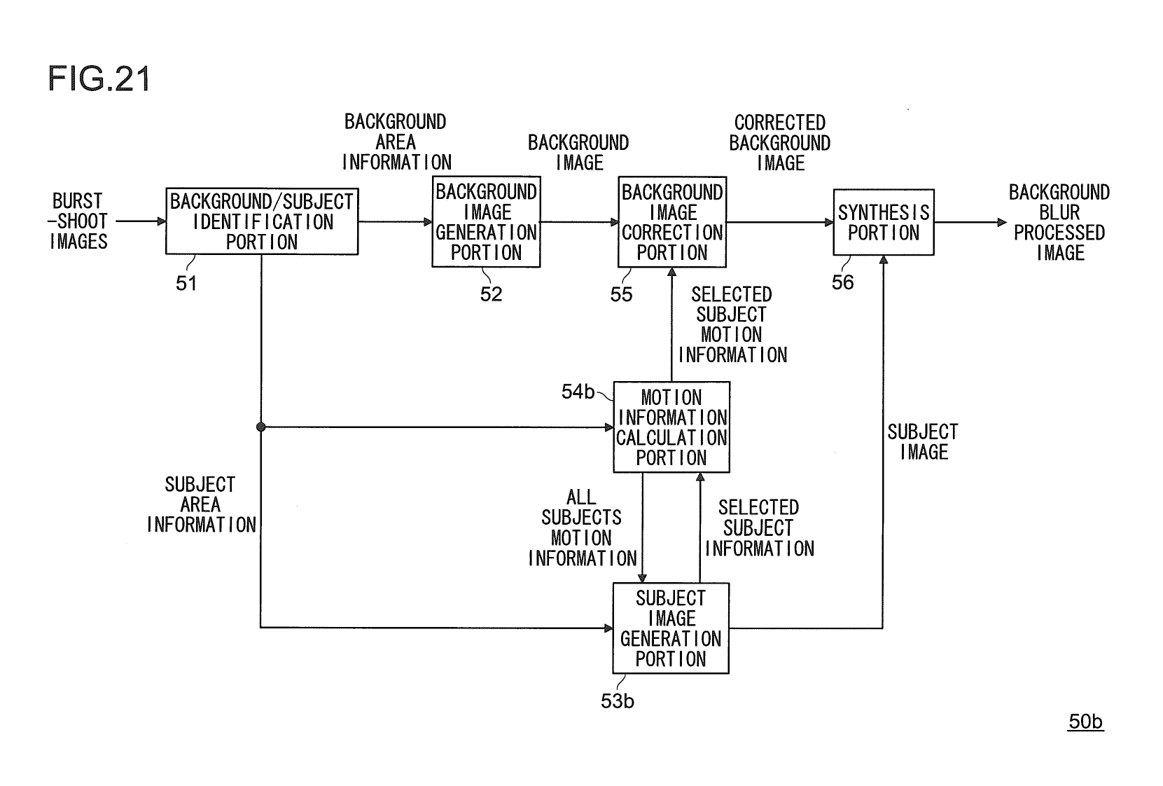

Next, a second embodiment of the blurred background processing portion is described with reference to the drawings. FIG. 6 is a block diagram depicting a configuration example of a blurred-background processing portion according to a second embodiment, and corresponds to FIG. 2 depicting the blurred background processing portion of the first embodiment. For the blurred background processing portion 50b of the second embodiment depicted in FIG. 21, portions with configurations comparable to those of the blurred background processing portion 50a of the first embodiment shown in FIG. 2 are assigned like labels and symbols, and are not discussed in detail. The descriptions of the various configurations discussed in relation to the blurred background processing portion 50a of the first embodiment may be implemented for the blurred background processing portion 50b of the present embodiment as well, provided that no conflicts arise from doing so.

As shown in FIG. 21, the blurred background processing portion 50b has a background/subject identification portion 51, a background image generation portion 52, a subject image generation portion 53b, a motion information calculation portion 54b, a background image correction portion 55, and a synthesis portion 56.

The motion information calculation portion 54b is adapted to calculate and output motion information of respective subjects shown by respective subject areas identified in the burst-shot images. The subject image generation portion 53b is adapted to select a subject for synthesis on the basis of motion information of the plurality of subjects output by the motion information calculation portion 54b, and output selected subject information.

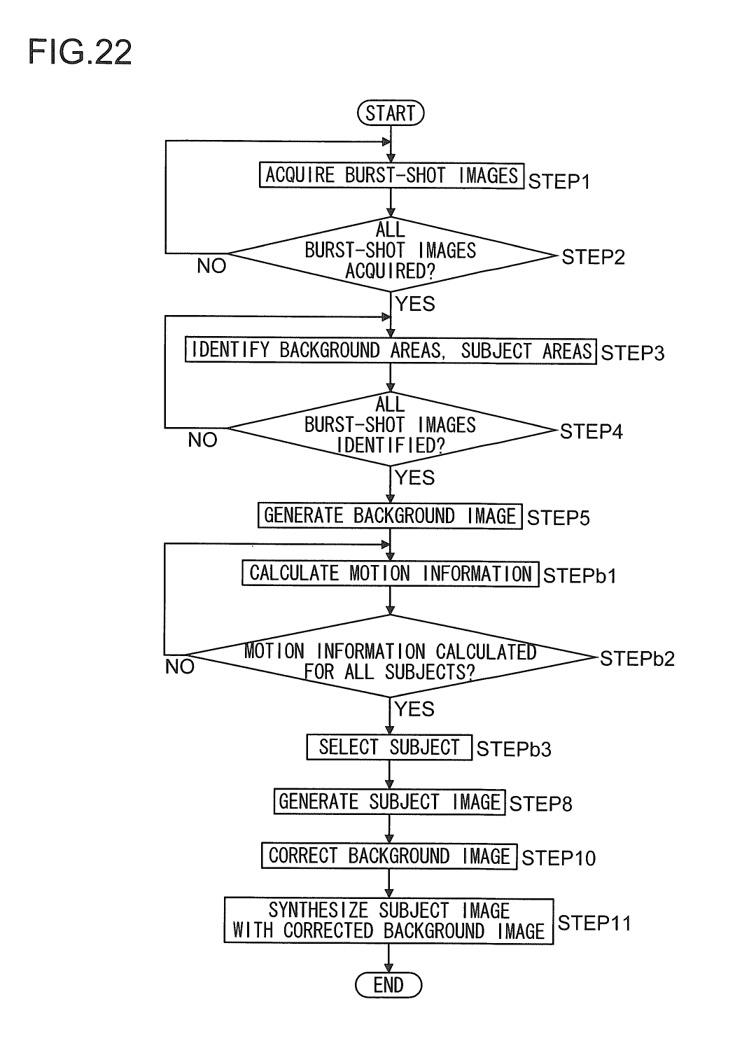

An example of operation of the blurred background processing portion 50b is now described with reference to the drawings. FIG. 22 is a flowchart depicting an example of operation of the blurred-background processing portion of the second embodiment, and corresponds to FIG. 3 shown for the blurred background processing portion of the first embodiment. For the example of operation of the blurred-background processing portion 50b of the second embodiment shown in FIG. 22, portions representing operations (STEPS) comparable to those of the example of operation of the blurred-background processing portion 50a of the first embodiment shown in FIG. 3 are assigned like STEP symbols, and are not discussed in detail. The descriptions of the various operations discussed in relation to the blurred background processing portion 50a of the first embodiment may be implemented for the present embodiment as well, provided that no conflicts arise from doing so.

As shown in FIG. 22, when the blurred background processing portion 50b initiates operation, it first acquires burst-shot images (STEP 1). The blurred background processing portion 50b acquires burst-shot images in succession (STEP 1) until all of the burst-shot images needed for the blurred background process are acquired (STEP 2, NO). Once the blurred background processing portion 50b has acquired all of the burst-shot images (STEP 2, YES), the background/subject identification portion 51 identifies the background areas and the subject areas of the acquired burst-shot images (STEP 3). The background/subject identification portion 51 carries out successive identification (STEP 3) until the background areas and the subject areas have been identified for the respective acquired burst-shot images (STEP 4, NO). Then, once the background/subject identification portion 51 has identified the background areas and the subject areas for the respective burst-shot images (STEP 4, YES), the background image generation portion 52 generates a background image on the basis of the background area information (STEP 5).

In the blurred background processing portion 50b of the present embodiment, next, the motion information calculation portion 54b calculates motion information of the subject (STEP b1). In the blurred background processing portion 50b of the present embodiment, motion information is successively calculated (STEP b1) until motion information is calculated for the respective subjects shown by all of the subject areas identified by the background/subject identification portion 51 (STEP b2, NO).

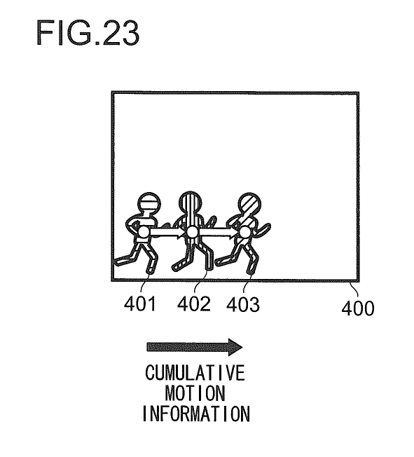

Once motion information has been calculated for all subjects (STEP b2, YES), the subject image generation portion 53b performs selection of a subject for synthesis. One example of this selection method is described with reference to FIG. 22. FIG. 23 is an illustration depicting an example of the subject selection method by the subject image generation portion of the blurred-background processing portion of the second embodiment.

FIG. 23 is an illustration showing a subject map image 400, and contains subject areas 401 to 403 identified from three burst-shot images. The subject area 401 is one identified from the burst-shot image that was shot chronologically first among the three burst-shot images, and the subject area 403 is one identified from the burst-shot image that was shot chronologically last among the three burst-shot images.

As shown in FIG. 23, motion information is respectively calculated, for example, for subject areas identified in two burst-shot images shot in chronological succession (the subject areas 401 and 402, or the subject areas 402 and 403), to arrive at motion information for all subjects (the white arrow in the drawing). Motion information (particularly extent of motion) evaluated for all of the subject areas 401 to 403 (for example, the sum of all extent of motion, or extent of motion calculated by comparing the subject areas 401 and 403) is designated as cumulative motion information (the black arrow in the drawing).

Then, a subject that fulfills a prescribed relationship in relation to cumulative motion information (e.g. a subject shot at a point in time equivalent to about half the cumulative extent of motion, i.e. when the extent of motion from the subject that was shot chronologically first to the subject to be selected is equivalent to about half the cumulative extent of motion) is selected as the subject for synthesis (STEP b3). In FIG. 23, in the event that the subject shot at a point in time equivalent to about half the cumulative extent of motion is selected as the subject for synthesis, the subject shown by the subject area 402 would be selected for example.

The selection method of the present example may be carried out based on the subject map image 400 as shown in FIG. 23, or carried out based on the subject area identification images, or images obtained by extracting images of subject areas from the burst-shot images. However, selection on the basis of the subject map image 400 is preferred, because it is possible to calculate motion information for all subjects based on a single image, and to easily select the subject for synthesis.

Once the subject for synthesis is selected as described above, the subject image generation portion 53b generates a subject image representing the subject (STEP 8), and outputs selected subject information indicating the subject in question. The motion information calculation portion 54b recognizes the selected subject on the basis of the selected subject information output by the subject image generation portion 53b, and outputs motion information of the subject.

Then, on the basis of the motion information output by the motion information calculation portion 54b, the background image correction portion 55 performs correction of the background image output by the background image generation portion 52 (STEP 10). The synthesis portion 56 then synthesizes the subject image generated by the subject image generation portion 53, with the background image obtained through correction by the background image correction portion 55 (STEP 11). A background blur processed image is generated thereby, and the blurred background processing portion 50b operation terminates.

With a configuration like that described above, it is possible for subject selection to take place based on motion conditions of the subject. Consequently, it is possible to generate a background blur processed image that represents the subject under motion conditions desired by the user.

The presentation image generation portion 57 shown in the first embodiment may be provided in this instance as well, using the presentation image generation portion 57 to generate a presentation image for confirmatory presentation to the user of the subject selected by the subject image generation portion 53b. The flowchart shown in FIG. 22 is merely one example, and it is possible to rearrange the order of the respective operations (STEPS) where no conflicts arise from doing so.

### Third Embodiment

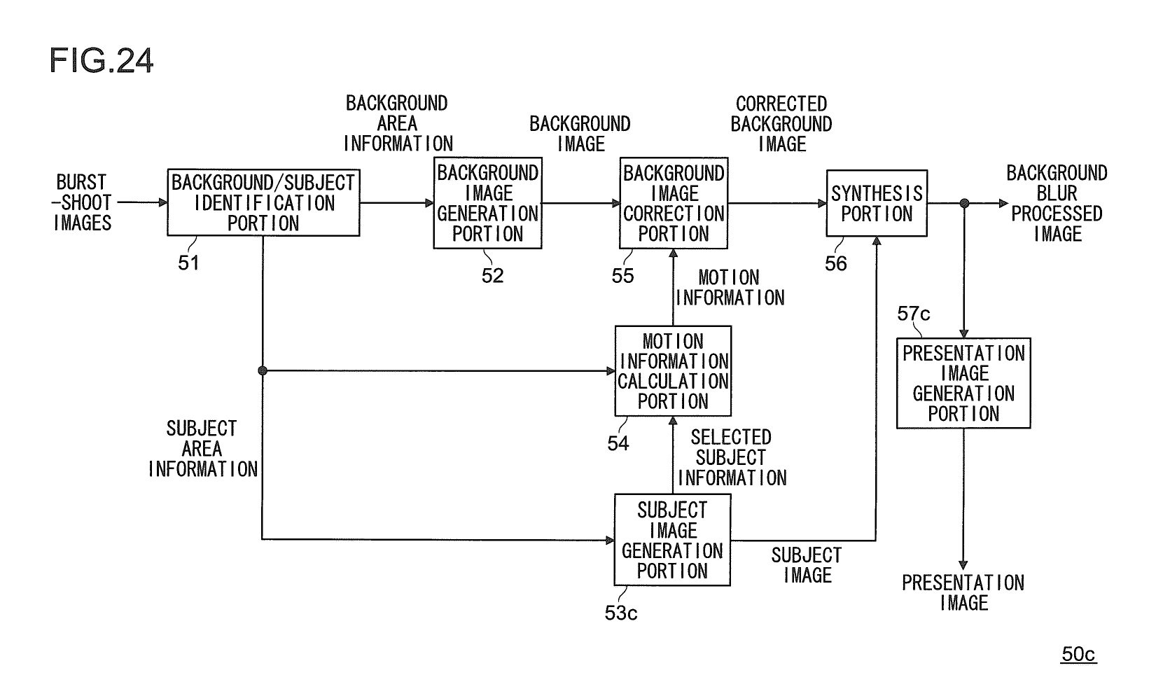

Next, a third embodiment of the blurred background processing portion is described with reference to the drawings. FIG. 24 is a block diagram depicting a configuration example of a blurred-background processing portion according to a third embodiment, and corresponds to FIG. 2 depicting the blurred background processing portion of the first embodiment. For the blurred background processing portion 50c of the third embodiment depicted in FIG. 24, portions with configurations comparable to those of the blurred background processing portion 50a of the first embodiment shown in FIG. 2 are assigned like labels and symbols, and are not discussed in detail. The descriptions of the various configurations discussed in relation to the blurred background processing portion 50a of the first embodiment may be implemented for the blurred background processing portion 50c of the present embodiment as well, provided that no conflicts arise from doing so.

As shown in FIG. 24, the blurred background processing portion 50c has a background/subject identification portion 51, a background image generation portion 52, a subject image generation portion 53c, a motion information calculation portion 54, a background image correction portion 55, a synthesis portion 56, and presentation image generation portion 57c.

The subject image generation portion 53c is adapted to successively select respective subjects shown by subject area information, and to generate subject images showing the subjects while outputting selected subject information indicating the respective subjects. The presentation image generation portion 57c is adapted to generate a presentation image showing the respective background blur processed images generated for the respective subjects.

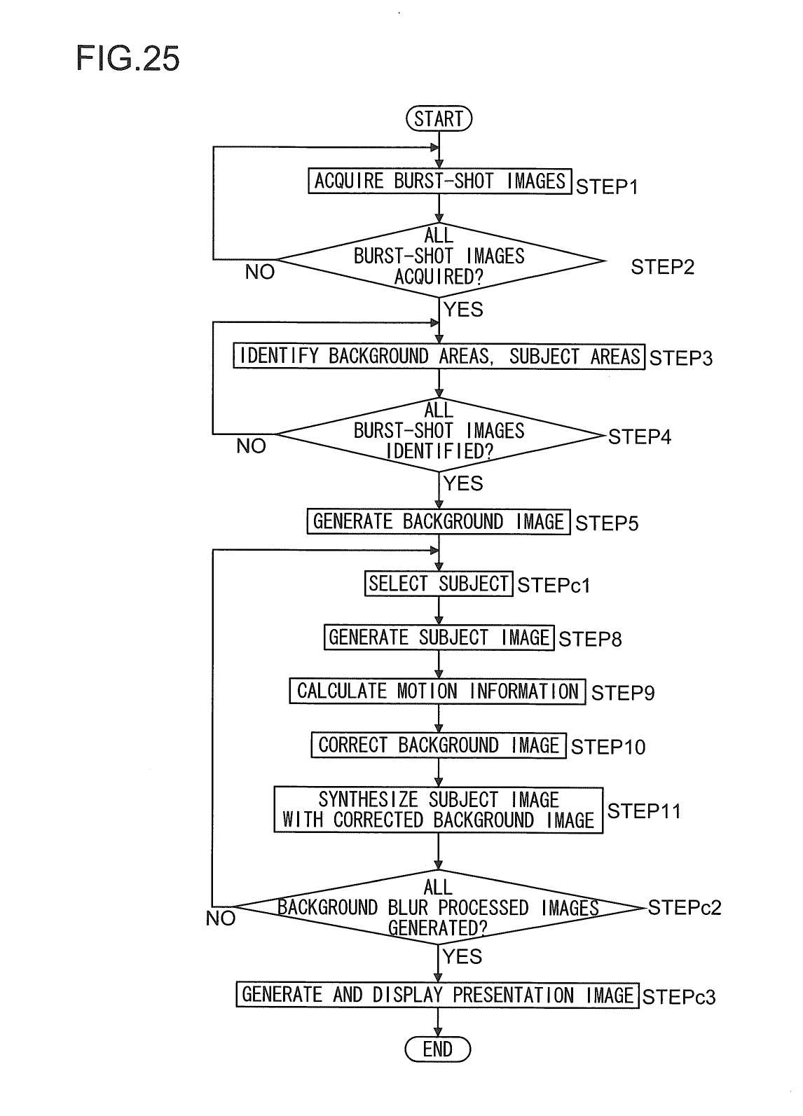

An example of operation of the blurred background processing portion 50c is now described with reference to the drawings. FIG. 25 is a flowchart depicting an example of operation of the blurred-background processing portion of the third embodiment, and corresponds to FIG. 3 shown for the blurred background processing portion of the first embodiment. For the example of operation of the blurred-background processing portion 50c of the third embodiment shown in FIG. 25, portions representing operations (STEPS) comparable to those of the example of operation of the blurred-background processing portion 50a of the first embodiment shown in FIG. 3 are assigned like STEP symbols, and are not discussed in detail. The descriptions of the various operations discussed in relation to the blurred background processing portion 50a of the first embodiment may be implemented for the present embodiment as well, provided that no conflicts arise from doing so.

As shown in FIG. 25, when the blurred background processing portion 50c initiates operation, it first acquires burst-shot images (STEP 1). The blurred background processing portion 50c acquires burst-shot images in succession (STEP 1) until all of the burst-shot images needed for the blurred background process are acquired (STEP 2, NO). Once the blurred background processing portion 50c has acquired all of the burst-shot images (STEP 2, YES), the background/subject identification portion 51 identifies the background areas and the subject areas of the acquired burst-shot images (STEP 3). The background/subject identification portion 51 carries out successive identification (STEP 3) until the background areas and the subject areas have been identified for the respective acquired burst-shot images (STEP 4, NO). Then, once the background/subject identification portion 51 has identified the background areas and the subject areas for the respective burst-shot images (STEP 4, YES), the background image generation portion 52 generates a background image on the basis of the background area information (STEP 5).

Next, the subject image generation portion 53c selects a subject (STEP c1) and generates a subject image representing the selected subject (STEP 8). The motion information calculation portion 54 calculates the motion information of the subject that was selected by the subject image generation portion 53c (STEP 9). The background image correction portion 55 then corrects the background image on the basis of the motion information calculated by the motion information calculation portion 54 (STEP 10), and the synthesis portion 56 synthesizes the subject image with the corrected background image to generate a background blur processed image (STEP 11).

In the blurred background processing portion 50c of the present embodiment, subject selection (STEP c1) takes place successively until all of the subjects that may be selected by the subject image generation portion 53c are selected (STEP c2, NO), then background blur processed images that contain the selected subjects are sequentially generated (STEPS 8 to 11).

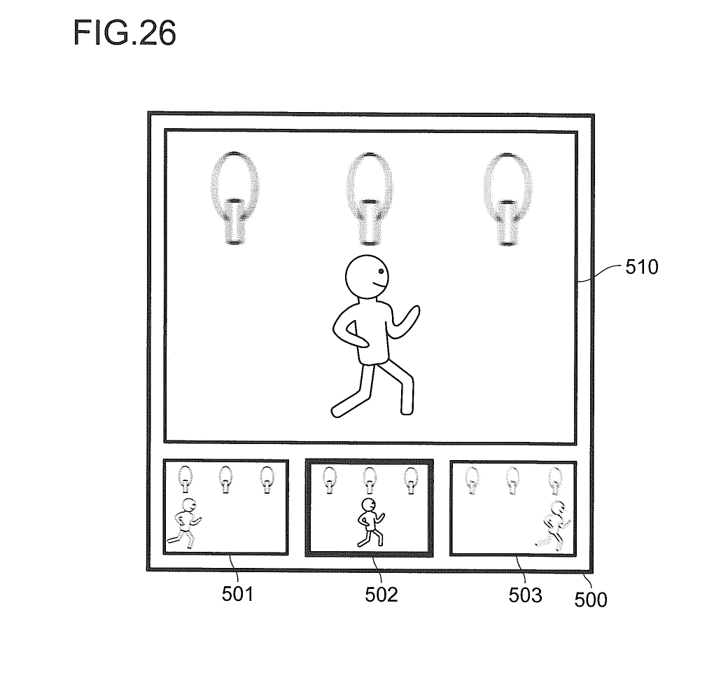

Once background blur processed images are generated for all subjects (STEP c2, YES), the presentation image generation portion 57c generates a presentation image using these background blur processed images. The presentation image is described with reference to FIG. 26. FIG. 26 is an illustration depicting an example of a presentation image generated by the presentation image generation portion of the blurred-background processing portion of the third embodiment.

As shown in FIG. 26, the presentation image 500 of the present example contains images 501 to 503 which are reduced versions of the plurality of background blur processed images generated for each subject and which are displayed in a row; and an enlarged image 510 displaying an enlarged version (e.g. through increase of the reduction factor, or through enlargement) of one image (the reduced image 502) that has been tentatively selected from among the reduced images 501 to 503.

The user may tentatively select any of the reduced images 501 to 503 via the control portion 17, and check the enlarged image 510 of the tentatively selected reduced image 502. If the user finds any of the background blur processed images represented by the reduced images 501 to 503 or the enlarged image 510 to be satisfactory, the selection is made via the control portion 17. The selected background blur processed image is then recorded to the external memory via the compression processing portion 9 and the driver portion 11.

Through a configuration such as that described above, it is possible for the user to actually verify a background blur processed image representing the effect of blurred background processing before deciding whether to record the image to the external memory 10. Thus, it is possible for the user to dependably record satisfactory background blur processed images, and to minimize instances of recording unwanted background blur processed images.

While FIG. 25 depicts an example in which a single background image is generated irrespective of the subject selection outcome, background images may be respectively generated according to the selected subject, as described for the blurred background processing portion 50a of the first embodiment. The flowchart shown in FIG. 25 is merely one example, and it is possible to rearrange the order of the respective operations (STEPS) if no conflicts would arise from doing so.

### Modified Examples

The respective operations of the image processing portion 5 and of the blurred background processing portions 50, 50a to 50c in the image-shooting device 1 according to the embodiments of the present invention may be carried out by a control unit such as a microcontroller or the like. Some or all of the functions accomplished by such a control unit may be described in computer program form, and some or all of these functions may be accomplished through execution of the program on a program execution device (e.g. a computer).

The image-shooting device 1 shown in FIG. 1 and the background processing portions 50a to 50c shown in FIGS. 2, 21, and 24 are not limited to their descriptions hereinabove; they may be realized through hardware or through a combination of hardware and software. Where portions of the image-shooting device 1 or of the background processing portions 50a to 50c are realized using software, blocks for the sites realized by software would represent function blocks of those sites.

While certain preferred embodiments of the present invention are described herein, it is to be understood that the scope of the invention is not limited thereto, and various modifications are possible without departing from the spirit of the invention.

The present invention relates to an image processing device adapted to generate a new image from a plurality of input images, and in particular to an image processing device adapted to generate images having a blurred background effect applied to the input image. The invention also relates to an image-shooting device furnished with the image processing device and adapted to shoot the plurality of images.

What is claimed is:

1. An image processing device comprising:
a background/subject identification portion which identifies respectively, for each of a plurality of burst-shot images shot successively over time, a background area which is an area representing a background, and a subject area which is an area representing a subject;
a background image generation portion which generates a background image which is an image representing a background, on the basis of the background area identified by the background/subject identification portion;
a subject image generation portion which generates a subject image which is an image representing a subject, on the basis of the subject area identified by the background/subject identification portion;
a correction portion which derives a direction of motion of a subject on the basis of the subject area identified by the background/subject identification portion, and which performs correction of the background image to create blur along the direction of motion of the subject; and
a synthesis portion which synthesizes the subject image with the background image corrected by the correction portion.

2. The image processing device according to claim 1 wherein
the background/subject identification portion respectively identifies the background area and the subject area based on a difference between at least two burst-shot images.

3. The image processing device according to claim 1 wherein
the correction portion derives the direction of motion of a subject represented by a subject image to be synthesized by the synthesis portion, and
the corrected background image to be synthesized with the subject image by the synthesis portion undergoes correction to create blur along the direction of motion of the subject.

4. The image processing device according to claim 1 wherein
the correction portion derives the extent of motion of respective subjects represented by respective subject areas identified by the background/subject identification portion,
the subject image generation portion generates a subject image representing a subject selected based on the extent of motion of the respective subjects, and
the synthesis portion synthesizes the subject image with the background image corrected by the correction portion.

5. The image processing device according to claim 1 wherein
the subject area of a given burst-shot image and the subject area of a burst-shot image shot chronologically before or after the given burst-shot image are used for the correction portion to derive the direction of motion of the subject represented by the subject area of the given burst-shot image.

6. An image-shooting device comprising:
an image-shooting portion which generates a plurality of burst-shot images shot successively over time; and
the image processing device of claim 1 which generates a blurred-background processed image on the basis of burst-shot images generated by the image-shooting portion.
